(19) United States
(12) Patent Application Publication
(10) Pub. No.: US 2002/0032030 A1
(43) Pub. Date: Mar. 14, 2002

(54) Communication system

(76) Inventors: Arne Kristian Berglund, Upplands Vasby (SE); David Bladsjo, Stockholm (SE); Stefan Eriksson, Stockholm (SE); Joakim Sorelius, Uppsala (SE)

Correspondence Address: JENKENS & GILCHRIST, PC, 1445 ROSS AVENUE, SUITE 3200, DALLAS, TX, 75202, US

(21) Appl. No.: 09/939,083

(22) Filed: Aug. 24, 2001

Related U.S. Application Data
(60) Provisional application No. 60/228,733, filed on Aug. 28, 2000.

(30) Foreign Application Priority Data
Aug. 28, 2000 (SE) 0003042.9

(51) Int. Cl. H04Q 7/20

(52) U.S. Cl. 455/434; 455/436

(57) ABSTRACT

Method in a communication system using a logical control channel transmitting a control channel message, including handover information, between a mobile station 10 and a base station 26, in said system, using a first control channel modulation scheme. The method comprises the step of re-transmitting the control channel message using a second control channel modulation scheme, if the control channel message using the first control channel modulation scheme is not received or understood by the mobile station. According to a preferred embodiment the control channel is a Fast Associated Control Channel (FACCH).

### FIELD OF THE INVENTION

The present invention relates to a method in a communication system and the communication system in accordance with the preambles of the independent claims.

### BACKGROUND OF THE INVENTION

U.S. Pat. No. 5,182,753 discloses a method of transmitting signaling messages in a mobile radio communication system and gives an overview of the principles applicable also in the present application.

FIG. 1 in the present application illustrates the basic configuration of a cellular mobile telecommunication system. Such a system comprises a number of cells, each cell comprising a base station for radio communication with a number of mobile stations, of which only one is shown in the figure. Basically the mobile station communicates with the base station of the cell in which it is presently moving. As the mobile moves from cell to cell, communication with the mobile station is handed over from the base station of one cell to the base station of another cell. This is called handover procedure. During handover procedure the old base station informs the mobile station to switch communication to another channel of the new base station. A handover command or message does this. However, since one of the reasons for the handover command in the first place is typically that the transmission conditions between the old base station and the mobile station are no longer acceptable, there is a risk that the handover command never reaches the mobile station or cannot be interpreted correctly by said station. In such a case there is a possibility that the call might be lost. One object of the present invention is to protect the handover command in such a way that the chances of correctly receiving it by the mobile station are significantly increased.

Although the detailed description of preferred embodiments of the present invention will concentrate of the handover command, it is to be understood that the same principles can also be used for other signaling messages, and that the invention is therefore not limited to handover commands only.

A Fast Associated Control Channel, FACCH, is a logical signaling channel for the transmission of control and supervision messages between the base station and the mobile station during an ongoing call. The FACCH by definition replaces or steals the speech or user data frames on the traffic channel whenever system considerations deem it appropriate to do so. Thus, the FACCH is a blank and burst channel.

In the above-mentioned U.S. Pat. No. 5,182,753 it is described how messages on the FACCH can be protected by means of error correcting and/or channel coding schemes. Further protection of critical messages, for instance the handover order, can be obtained by retransmission of the coded message if acknowledgement is not received within a specified time period, by sending the message repeatedly in one sequence until acknowledgement is received, by sending the message repeatedly a fixed number of times without requiring acknowledgement, or by sending the message repeatedly a fixed number of times or until acknowledgement has been received. The radio link quality is often fluctuating and it is hoped that the mobile then will by able to receive the message properly at least once.

General packet radio service (GPRS) is a standard from the European Telecommunications Standards Institute (ETSI) on packet data in GSM systems. GPRS has also been accepted by the Telecommunications Industry Association (TIA) as the packet-data standard for TDMA/136 systems. By adding GPRS functionality to the public land mobile network (PLMN), operators can give their subscribers resource-efficient access to external Internet protocol-base (IP) networks.

GPRS offers air-interface transfer rates up to 115 kbit/s subject to mobile terminal capabilities and carrier interference. Even higher transfer rates are provided by the use of so called EDGE technology, i.e. Enhanced Data Rates for Global Evolution. EDGE technology can increase end user data rates up to 384 kbit/s, and potentially higher in high quality radio environments. Moreover, GPRS allows several users to share the same air-interface resources and enables operators to charge customers for wireless services based on the amount of transferred data instead of on connection time.

The present invention is in particular applicable in GSM/EDGE Radio Access Network (GERAN).

When introducing an 8-PSK modulation for radio transmission of speech in GERAN, the associated control channels have to be specified. An especially important control channel is the above-mentioned Fast Associated Control Channel (FACCH).

Due to the importance of the FACCH messages, this control channel is designed so that it is transmitted instead of speech frames. Because the speech has very high delay requirements, there is no meaning in transmitting the blanked speech frames at a later time.

It is important to design the FACCH so that a minimal number of speech frames are blanked in order to avoid bad speech quality. This is achieved when the FACCH has the same type of interleaving as the speech. However, it is also important to make the FACCH as robust as possible when the radio connection has been deteriorated, as a handover is likely to be necessary at such conditions.

Different modulation methods for the FACCH for the 8-PSK speech bearer may be used: e.g. 8-PSK modulated FACCH and GMSK modulated FACCH. 8-PSK modulated FACCH blanks a minimum number of speech frames as it can be interleaved in the same way as speech data. However, one potential problem of 8-PSK modulation is its limited robustness in bad channel conditions. GMSK modulated FACCH is more robust to the propagation channel than 8-PSK modulated FACCH and can be transmitted at a higher power, which is well-known in the art, but results in the blanking of more speech frames due to the different interleaving pattern.

There is currently no possibility to make a trade-off between the requirements of minimal blanking of speech frames and robustness.

U.S. Pat. No. 5,909,469, assigned to the same assignee as the present application, discloses a link adaptation method and system for communication links using modulation schemes that have different symbol rates. The system supports at least two modulation schemes that do not have the same symbol rate. The system measures the performance of the communication. This measurement may be performed by determining a number of parameters, including received signal strength at the mobile station, bit error rate at the mobile station, the multipath propagation property of the uplink RF channel, for example, time dispersion, or a combination thereof. A higher (less robust) modulation scheme is maintained if the performance of the communication is acceptable, i.e. above some predetermined threshold. If the performance is not acceptable the modulation scheme is changed to a more robust one. In above-referenced U.S. Pat. No. 5,909,469 the change of modulation scheme for the communication is performed in response to a continuously measured quality measure of the traffic channel radio-link. U.S. Pat. No. 5,909,469 is not concerned with transmission on logical control channels specifically.

The object of the present invention is to achieve a system where an optimal performance of the system is achieved, i.e. to achieve a robust logical control channel so that a minimum of speech frames are blanked.

### SUMMARY OF THE INVENTION

The above-mentioned object is achieved by a method and a system according to the characterizing parts of the independent claims.

Preferred embodiments are set forth in the dependent claims.

Thus, by using a control channel that is modulation adaptive, the above-mentioned objects are achieved.

According to a preferred embodiment the used control channel is a FACCH. However, the invention is applicable on any control channel transmitting signaling messages during ongoing calls, e.g. handover information, in a communication system.

According to the preferred embodiment of the invention the network first transmits the FACCH message using the 8-PSK modulation, thus blanking a minimal number of speech frames. If this transmission fails, i.e. if the mobile station does not properly receive the FACCH message (detected by the network, e.g. that no acknowledgement is transmitted to the base station or if no handover is performed), the FACCH is retransmitted using the GMSK modulation. Then more speech frames are blanked, but it can be expected that the channel quality is so low that the speech is close to unintelligible anyway.

The system according to the preferred embodiment of the invention combines the minimal speech quality impact that comes from using the 8-PSK modulation, with the robustness of the GMSK modulation.

### SHORT DESCRIPTION OF THE APPENDED DRAWINGS

FIG. 1 illustrates the basic configuration of a cellular mobile telecommunication system,

FIG. 2 illustrates an exemplary communication system in which the present invention may be implemented.

FIGS. 3a and 3b illustrate interleaving patterns when the FACCH message is transmitted with 8-PSK modulation and GMSK modulation, respectively.

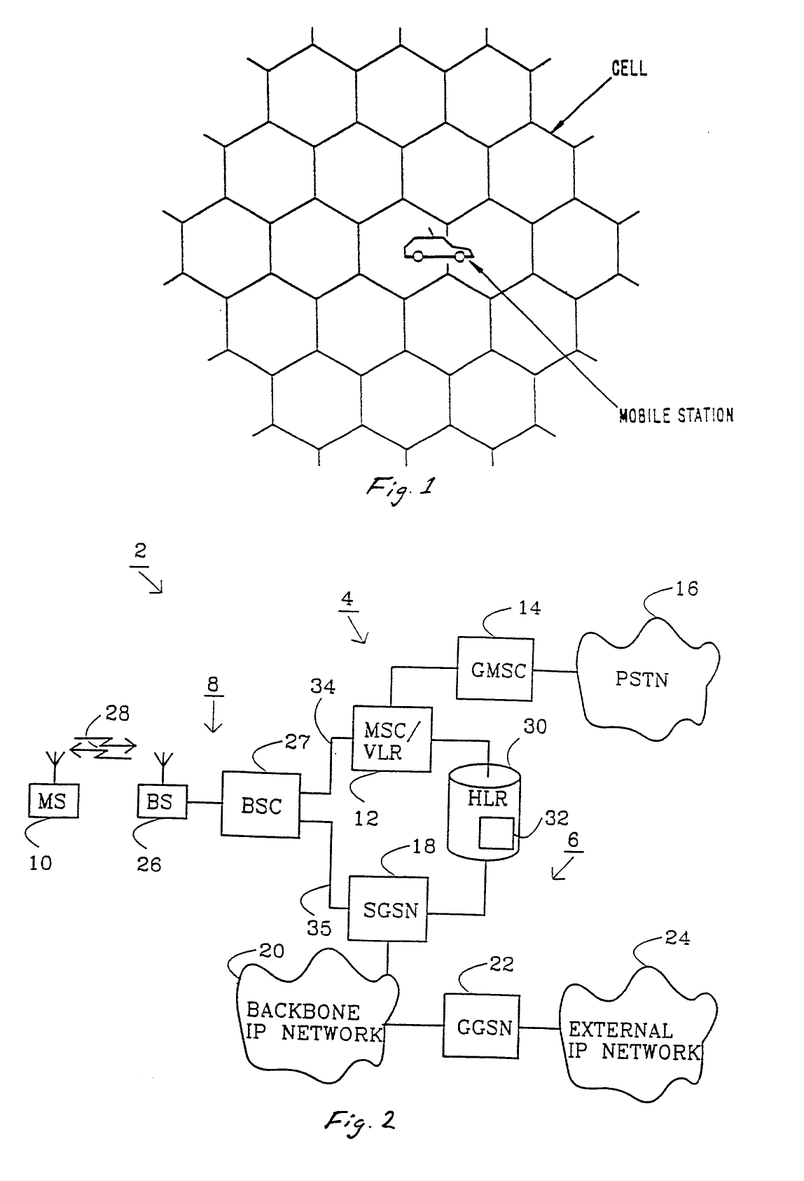

### DETAILED DESCRIPTION OF PREFERRED EMBODIMENTS OF THE INVENTION

FIG. 2 illustrates an exemplary communication system 2 in which the present invention may be implemented. In particular the system 2 depicted in FIG. 2 conforms to the GSM specifications and supports GPRS and Enhanced GPRS (EGPRS) (e.g. GERAN) technology. The mobile telecommunications system 2 includes a circuit-switched network 4, a packet-switched network 6, and a radio network 8 that is shared by the circuit-switched an packet-switched networks 4 and 6. Generally, the circuit-switched network 4 is primarily used for voice applications, while the packet-switched network 6 is primarily used for data applications. In accordance with third generation mobile telecommunications standard, however, the circuit-switched network 4 can also support data communications, and the packet-switched network 6 can also support voice communications.

The circuit-switched network 4 includes a number of mobile services switching center/visitor location registers (MSC/VLRs) 12. For purposes of simplifying the illustration, however, only on MSC/VLR 12 is shown. Each MSC/VLR 12 serves a particular geographic region and is used for controlling communications in the served region and for routing communications to other MSC/VLRs 12. The VLR portion of the MSC/VLR 12 stores subscriber information relating to mobile stations 10 that are currently located in the served region. The circuit-switched network 4 further includes at least one gateway mobile services switching center (GMSC) 14 that serves to interconnect the circuit-switched network 4 withc external networks, such as a public switched telephone network (PSTN) 16.

The packet-switched network 6 includes a number of serving GPRS support nodes (SGSN) 18, which are used for routing and controlling packet data communications, and a backbone IP network 20. A gateway GPRS support node (GGSN) 22 interconnects the packet-switched network 6 with an external IP network 24 or other external data networks.

The radio network 8 includes a plurality of cells. Each cell in the mobile telecommunications system 2 is served by a base station 26 that communicates with mobile stations 10 in the cell via an air interface 28. The radio network 8 comprises a plurality of base stations 26 and a base station controller (BSC) 27, alternatively referred to as a Radio Network Controller (RNC), controlling said plurality of base stations 26. For circuit-switched communications, signals are routed from the MSC/VLR 12, to the base station controller 27 via an interface 34, to the base station 26 for the cell in which the target mobile station 10 is currently located, and over the air interface 28 to the mobile station 10. For packet data transmissions, on the other hand, signals are routed from the SGSN 18, to the base station controller 27 via an interface 35, to the base station 26 for the cell in which the target mobile station 10 is currently located, and over the air interface 28 to the mobile station 10.

Each mobile station 10 is associated with a home location register (HLR) 30. The HLR 30 stores subscriber data for the mobile station 10 that is used in connection with circuit-switch communications and can be accessed by the MSC/VLRs 12 to retrieve subscriber data relating to circuit-switched services.

Each mobile station 10 is also associated with a GPRS register 32. The GPRS register 32 stores subscriber data for the mobile station 10 that is used in connection with packet-switched communications and can be accessed by the SGSNs 18 to retrieve subscriber data relating to packet-switched services.

The handover procedure between a mobile station and a base station in a communication system was generally described above in the general part of the description. In order to fully understand the present invention, a description of an exemplary handover procedure which may be used in GSM systems and using a FACCH as the control channel is given below.

When a mobile station is moving around in a network, it eventually leaves the coverage area of one cell and enters another one. If there is no call in progress, the mobile station will tell the network if it has left one location area and in that case update the registration about its location area in the network. If there is a call going on, the network decides when it is time to change cells and to which new cell (to perform a handover). The network takes the decision mainly based on the measurement reports from the mobile station. The performance of the handover procedure on the air interface will be described, e.g. how messages and timers are involved in the air interface for a handover. After the network has decided that a handover will be performed it sends a Handover Command message on the downlink FACCH. This message contains information on which new cell the mobile shall access and which frequency and time slot to use for the new Traffic Channel (TCH). It also specifies whether a synchronized handover (including type) shall be performed by the mobile station. In the case of frequency hopping, a list of hopping frequencies to be used is also added.

The number of bits necessary for the message will today not exceed 184 in GSM, but more bits are needed for a frequency hopping DCS 1800 system. For GSM one message frame is needed while two frames are needed for DCS 1800 if frequency hopping is used. If necessary even more than two frames may be used. The maximum number of frames that a message can contain is limited to 13 for FACCH.

A synchronized handover can be made in three different ways although the messages transmitted after the Handover Command are the same. The difference lies in the way the time alignment is calculated from the information in the Handover Command message.

After reception of a Handover Command message the mobile station suspends the acknowledge mode, tunes to the new channel, transmits four Handover Access bursts and then initiates an establishment of acknowledge mode. After establishment, the mobile station transmits the Handover Complete message to finish the handover.

In the non synchronized handover case, after reception of a Handover Command and suspension of acknowledge mode, the mobile sends Handover Access bursts in consecutive FACCH time slots. The Handover Access bursts are transmitted until a reception of a Physical Information message from the network, or until a timer expires. The timer is set when the first Handover Access burst is transmitted.

The network must correctly receive two of three Handover Access bursts to continue and transmit a Physical Information message. The physical information message contains the calculated time alignment from the reception of the access bursts and is transmitted in an unnumbered information frame, thus the mobile station does not need to acknowledge this message. Therefore the network sets a timer when transmitting the Physical Information message. If this timer expires before receiving a correct speech or message frame, the network retransmits the Physical Information message frame. The first time the Physical Information message is transmitted, it is transmitted in two consecutive frames. A constant set to a default value limits the number of retransmissions.

After reception of a Physical Information the Handover Complete message is transmitted from the mobile station.

The Handover Complete message tells the network that the handover has been successful. After receiving a Handover Complete message the system erases the allocation of the old channel, thus the old channel hereafter is free to be used by another user.

Below are described situations that might occur when, for some reason, the FACCH Handover Command message is not properly received by the mobile station, including the case that the message is not received at all.

If a preset timer expires or the establishment of acknowledge mode on the new channel fails, the mobile station returns to the old channel, initiates an establishment of acknowledge mode and then transmits a Handover Failure message containing the failure reason.

If Handover Complete, Handover Failure or the establishment on the old channel is unsuccessful, the mobile station will consider itself as lost and a specified procedure (not within the scope of the present application) is followed.

The present invention is applicable during the above-described handover procedure whenever the network detects that the mobile station has failed to properly receive the various signaling messages transmitted from the base station. In practice, this may basically be detected in three different ways:

1. The mobile station continues to transmit speech frames on the old channel

2. The mobile station sends the Handover Failure message

3. No acknowledge message, e.g., Handover Complete, is received from the mobile station as stipulated.

Referring back to FIG. 2 the present invention is primarily implemented in the radio network 8 that comprises a plurality of base stations 26 and a base station controller (BSC) 27 controlling said plurality of base stations 26.

In the method according to the invention, a communication system transmits a control signaling message, including e.g. handover information, during an ongoing call connection between a mobile station and a base station on a logical control channel using a first control channel modulation scheme. The logical control channel is used during an ongoing call, e.g. when the quality of the radio communication, e.g. data or voice communication, is low. This is determined in accordance with well established techniques and is therefore not further described herein. The method comprises the step of re-transmitting the control channel message using a second control channel modulation scheme, if the control channel message using the first control channel modulation scheme is not received or understood by the mobile station. According to a preferred embodiment the re-transmission of the control channel message is triggered by a failed handover, i.e. the control channel message indicates that a handover should be performed but no handover is performed. This may be detected as described above.

In the general case the control channel modulation scheme may thus be changed for re-transmission if no acknowledgement message is transmitted from the mobile station to the base station confirming proper receipt of the control channel message.

According to another preferred embodiment of the invention the control channel is a Fast Associated Control Channel (FACCH). The FACCH is described in detail in the above-referenced U.S. Pat. No. 5,182,753.

According to still another preferred embodiment of the invention the first control channel modulation scheme is an 8-PSK modulation and the second control channel modulation scheme is a GMSK modulation. However, the invention is equally applicable when using any known control channel modulation schemes, such as: GMSK, 4-PSK, 8-PSK, 16 QAM and 64 QAM.

As mentioned above the first control channel modulation scheme may involve a lower number of blanked speech frames than the second control channel modulation scheme. The reason is that an 8-PSK modulated control message, in the embodiment using 8-PSK and GMSK as the first and second control channel modulation scheme, uses the same interleaving pattern as the 8-PSK modulated voice bearer. Therefore, the control message will fit exactly into the interleaving sequence without having to transmit empty frames as will be explained below.

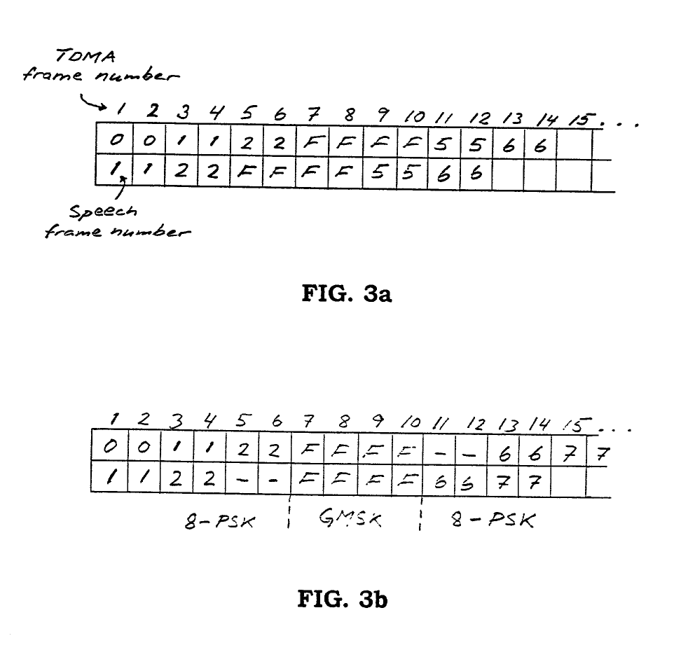

FIG. 3a illustrates the interleaving pattern when the FACCH message (F) is transmitted with 8-PSK modulation. During speech, each TDMA (Time Division Multiple Access) frame burst contains bits which are interleaved from two speech frames, e.g., the bursts in TDMA frames 1 and 2 contain bits from both speech frames 0 and 1, TDMA frames 3 and 4 contain bits from both speech frames 1 and 2 and so forth. When the FACCH message is transmitted, the FACCH frames F can replace speech frames 3 and 4 in TDMA frames 5-10 since the same modulation enables that FACCH and speech can share TDMA frames.

FIG. 3b illustrates the interleaving pattern when the FACCH message (F) is transmitted with GMSK modulation. In this case, the modulation changes from 8-PSK to GMSK in TDMA frame 7 and goes back again to 8-PSK in TDMA frame 11. The modulation change can not occur in the middle of a speech frame but must wait until speech frame 2 in this case is transmitted, i.e. after TDMA frame 6. The FACCH is then transmitted during TDMA frames 7-10, but three speech frames 3, 4 and 5 are blanked instead of only two speech frames 3 and 4 as in FIG. 3a.

According to still another embodiment of the invention the method comprises the step of re-transmitting the control channel message using a third control channel modulation scheme, if the control channel message using the second control channel modulation scheme is not received or understood by the mobile station. This step is triggered in the same way as when changing from the first to the second modulation scheme.

The present invention is not limited to the above-described preferred embodiments. Various alternatives, modifications and equivalents may be used. Therefore, the above embodiments should not be taken as limiting the scope of the invention, which is defined by the appendant claims.

1. Method in a radio communication system using a logical control channel for transmitting control signaling messages from a base station to a mobile station during an ongoing call, characterized in that the method comprises the steps of:
transmitting from the base station at least one control signaling message using a first modulation scheme,
detecting that the mobile station has not properly received and understood said message, and
re-transmitting said control signaling message using a second modulation scheme in response to said detecting step.

2. Method according to claim 1, characterized in that said logical control channel is transmitted on a traffic channel of said ongoing call using blank and burst.

3. Method according to claim 2, characterized in that said logical control channel is a Fast Associated Control Channel (FACCH).

4. Method according to claim 1, characterized in that said at least one control signaling message includes handover information.

5. Method according to any preceding claim, characterized in that said first control channel modulation scheme is the 8-PSK modulation.

6. Method according to any preceding claim, characterized in that said second control channel modulation scheme is the GMSK modulation.

7. Method according to any preceding claim, characterized in that the first control channel modulation scheme involves a lower number of blanked speech frames than the second control channel modulation scheme.

8. Method according to any preceding claim, characterized in that the first control channel modulation scheme is less robust than the second control channel modulation scheme.

9. Method according to any preceding claim, characterized in that said detecting step includes detecting that no acknowledge message is received by the base station confirming receipt of the control channel message.

10. Method according to any preceding claim, characterized in that said detecting step includes receiving by the base station a message indicating a failed handover.

11. Method according to any of claims 4-8, characterized in that said detecting step includes detecting that the mobile station continues to transmit on an old channel.

12. Method according to any preceding claim, characterized in that the method comprises the steps of:
detecting that the mobile station has not properly received and understood said message transmitted by use of said second modulation scheme, and
re-transmitting said control signaling message using a third modulation scheme in response to said detecting step.

13. Radio communication system comprising base stations (26), mobile stations (10) and a control unit (27) controlling at least one of said base stations, wherein the control unit controls the base station to transmit at least one control signaling message to a mobile station during an ongoing call using a logical control channel, characterized in that the control unit further controls the base station to re-transmit said at least one control signaling message using a second modulation scheme in response to detecting that the mobile station has not properly received and understood said message as transmitted using said first modulation scheme.

14. Radio communication system according to claim 13, characterized in that said control unit (27) is a Base Station Controller (BSC).

15. Radio communication system according to any of claim 13 or 14, characterized in that said logical control channel is a blank and burst channel.

16. Radio communication system according to any of claims 13-15, characterized in that said at least one control signaling message includes handover information.

17. Communication system according to any of claims 13-16, characterized in that said control channel is a Fast Associated Control Channel (FACCH).

18. Communication system according to any of claims 13-17, characterized in that said first control channel modulation scheme is the 8-PSK modulation.

19. Communication system according to any of claims 13-18, characterized in that said second control channel modulation scheme is the GMSK modulation.

20. Communication system according to any of claims 13-19, characterized in that the first control channel modulation scheme involves a lower number of blanked speech frames than the second control channel modulation scheme.

21. Communication system according to any of claims 13-20, characterized in that the first control channel modulation scheme is less robust than the second control channel modulation scheme.

22. Communication system according to any of claims 13-21, characterized in that the detection that the mobile station has not properly received and understood said message includes that no acknowledge message is received by the base station confirming receipt of the control channel message.

23. Communication system according to any of claims 13-21, characterized in that the detection that the mobile station has not properly received and understood said message includes receiving by the base station a message indicating a failed handover.

24. Communication system according to any of claims 13-21, characterized in that the detection that the mobile station has not properly received and understood said message includes that the mobile station continues to transmit on an old channel.
